(19) United States
(12) Patent Application Publication
(10) Pub. No.: US 2007/0044274 A1
(43) Pub. Date: Mar. 1, 2007

(54) Locking door stop

(76) Inventors: Andrew Chen, Shih Lin (TW); Jinn-Yi Deng, Hua Tan Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/219,627

(22) Filed: Sep. 1, 2005

(51) Int. Cl. E05F 5/02

(52) U.S. Cl. 16/82

(57) ABSTRACT

A locking door stop includes a fixing seat, a catch rod, a locking plate, and an anti-skid pad. Thus, the anti-skid pad is freely rotatable relative to the catch rod to fit the inclined angle of the ground so that the door stop has an automatic angle adjustment function so as to fit the inclined angle of the ground. In addition, the spring is compressed during movement of the resting portion of the catch rod to produce an elastic compensation effect to the anti-skid pad, so that the anti-skid pad is positioned on the ground solidly and stably.

### BACKGROUND OF THE INVENTION

1. Field of the Invention

The present invention relates to a door stop, and more particularly to a locking door stop.

2. Description of the Related Art

A conventional locking door stop in accordance with the prior art shown in FIGS. 4 and 5 comprises a fixing seat 100, a catch rod 200, a locking plate 300, and an anti-skid pad 400. The fixing seat 100 has an inside formed with a receiving recess 103 having a top face formed with a top through hole 104 and a bottom face formed with a bottom through hole 105. The fixing seat 100 has a side formed with an insertion slot 102 located adjacent to the receiving recess 103 and a periphery formed with a plurality of screw holes 101 for attaching the fixing seat 100 to a door 50. The catch rod 200 is slidably mounted in the receiving recess 103 of the fixing seat 100 and has a top end protruded from the top through hole 104 of the fixing seat 100 and formed with an enlarged pedal 201, a mediate portion formed with an annular groove 202 for mounting a snap ring 203 and a bottom end protruded from the bottom through hole 105 of the fixing seat 100. A compression spring 106 is mounted around the catch rod 200 and pressed between the bottom face of the receiving recess 103 of the fixing seat 100 and the snap ring 203. The locking plate 300 is mounted on the catch rod 200 and has an inside formed with an eccentrically arranged locking hole 302 locked on the catch rod 200 in an inclined manner and has an end formed with a protruding insert 301 inserted into the insertion slot 102 of the fixing seat 100. A biasing member 303 is mounted around the catch rod 200 and biased between the fixing seat 100 and the locking plate 300 so that the locking plate 300 is normally disposed at an inclined state relative to the catch rod 200 so as to lock the catch rod 200. The anti-skid pad 400 is secured on the bottom end of the catch rod 200 to move therewith and has an inside formed with a mounting recess 401 mounted on the bottom end of the catch rod 200.

In operation, the fixing seat 100 is secured to the bottom of the door 50 by the screw holes 101. When the door 50 is opened to a determined position, the pedal 201 of the catch rod 200 is stepped by a user to push the catch rod 200 to move downward to move the anti-skid pad 400 downward until the anti-skid pad 400 is rested on the ground 60 so that the door 50 is stopped by friction between the anti-skid pad 400 and the ground 60.

However, if the catch rod 200 is not positioned exactly, the catch rod 200 easily slips upward due to vibration or wind force, thereby releasing the door 50. In addition, the anti-skid pad 400 is secured on the bottom end of the catch rod 200 so that the angle between the anti-skid pad 400 and the catch rod 200 is fixed and cannot be adjusted. Thus, the anti-skid pad 400 only has a partial area contacting the ground 60 when the ground 60 is not perpendicular with door 50, thereby decreasing the stopping effect of the door stop.

### SUMMARY OF THE INVENTION

The primary objective of the present invention is to provide a door stop having an angle adjustment function.

Another objective of the present invention is to provide a door stop, wherein the anti-skid pad is freely rotatable relative to the catch rod to fit the inclined angle of the ground so that the door stop has an automatic angle adjustment function so as to fit the inclined angle of the ground.

A further objective of the present invention is to provide a door stop, wherein the spring is compressed during movement of the resting portion of the catch rod to produce an elastic compensation effect to the anti-skid pad, so that the anti-skid pad is positioned on the ground solidly and stably.

### BRIEF DESCRIPTION OF THE DRAWINGS

FIG. 1 is an exploded perspective view of a door stop in accordance with the preferred embodiment of the present invention;

FIG. 2 is a plan cross-sectional assembly view of the door stop as shown in FIG. 1;

FIG. 3 is a schematic operational view of the door stop as shown in FIG. 2 in use;

FIG. 4 is an exploded perspective view of a conventional door stop in accordance with the prior art; and

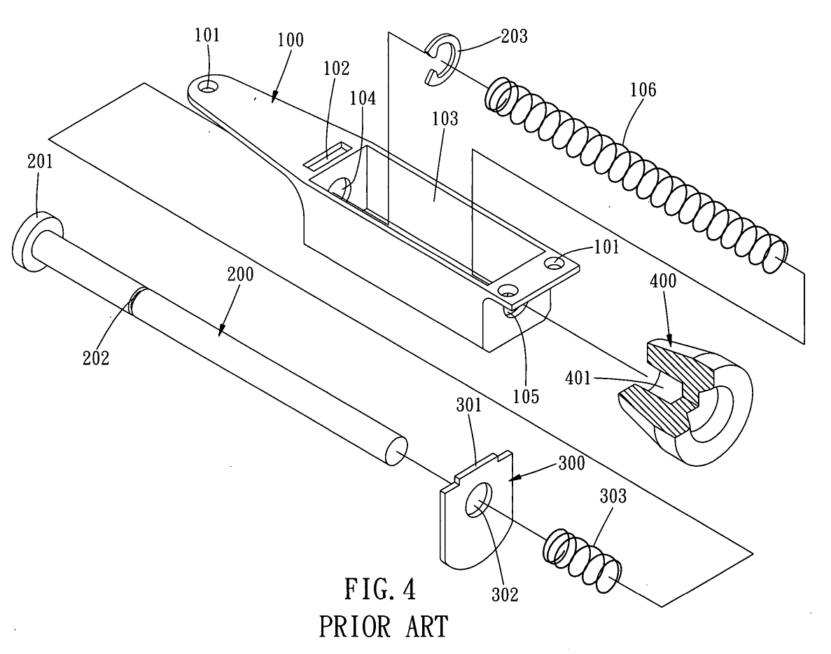

FIG. 5 is a plan cross-sectional assembly view of the conventional door stop as shown in FIG. 4.

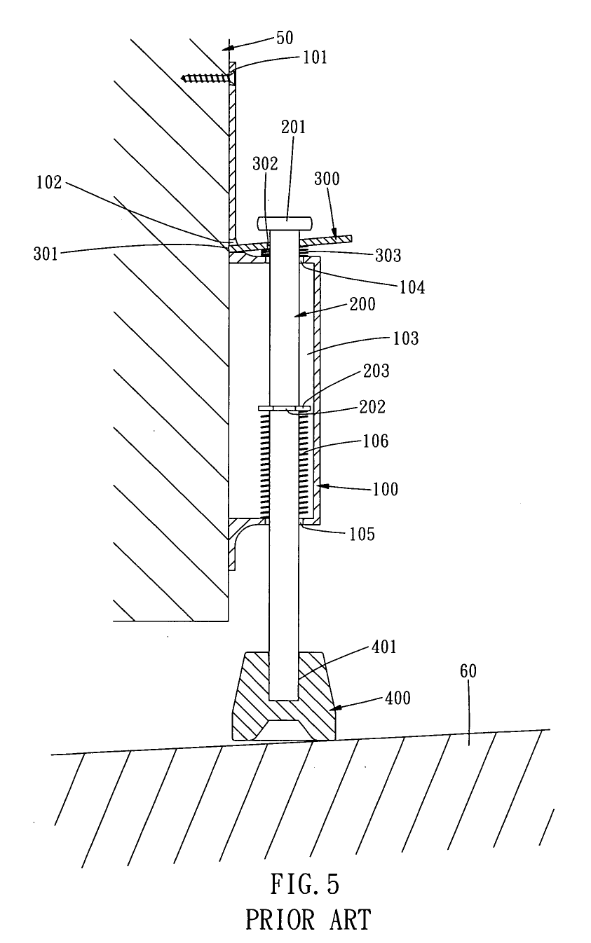

### DETAILED DESCRIPTION OF THE INVENTION

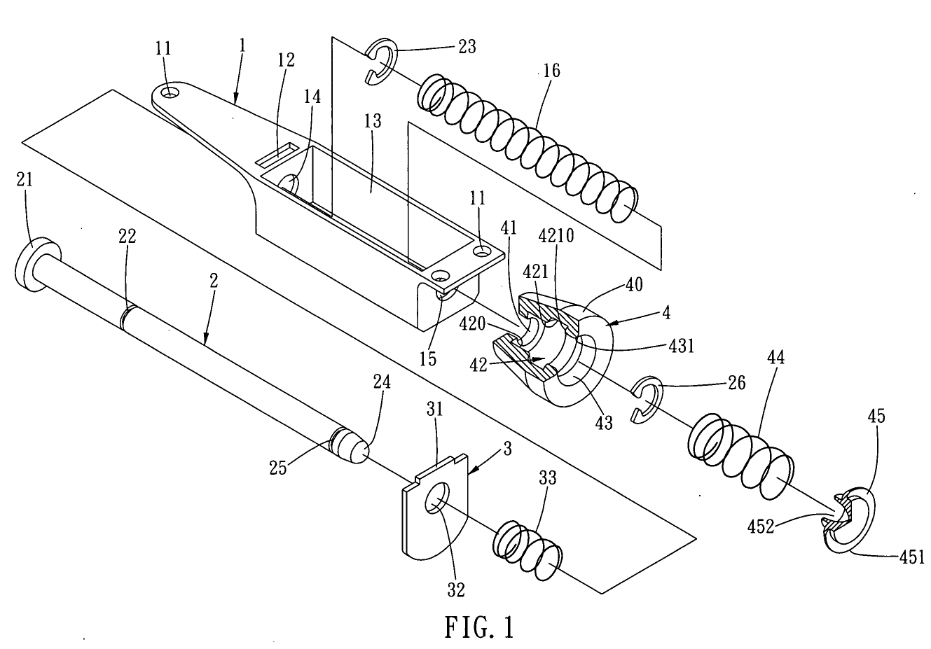

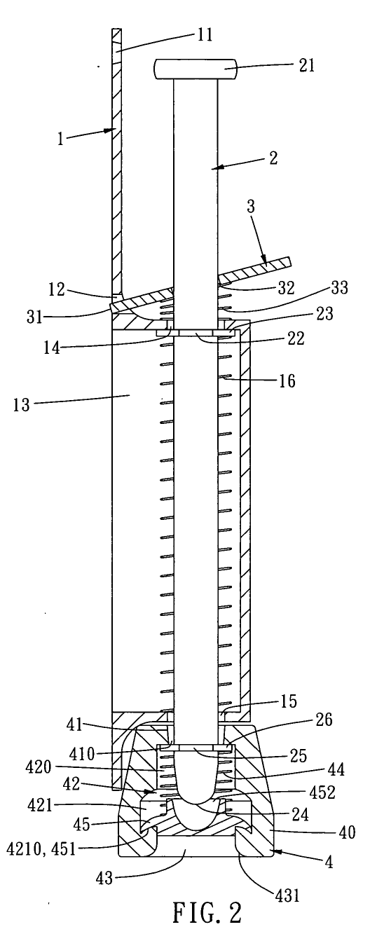

Referring to the drawings and initially to FIGS. 1 and 2, a locking door stop in accordance with the preferred embodiment of the present invention comprises a fixing seat 1, a catch rod 2, a locking plate 3, and an anti-skid pad 4.

The fixing seat 1 has an inside formed with a receiving recess 13 having a top face formed with a top through hole 14 and a bottom face formed with a bottom through hole 15. The fixing seat 1 has a side formed with an insertion slot 12 located adjacent to the receiving recess 13. The fixing seat 1 has a periphery formed with a plurality of screw holes 11.

The catch rod 2 is slidably mounted in the receiving recess 13 of the fixing seat 1 and has a top end protruded outward from the top through hole 14 of the fixing seat 1 and formed with an enlarged pedal 21 and a bottom end protruded outward from the bottom through hole 15 of the fixing seat 1 and formed with a substantially arc-shaped resting portion 24 and an annular retaining groove 25 for retaining a substantially C-shaped limit ring 26. The catch rod 2 has a mediate portion formed with an annular snapping groove 22 for mounting a substantially C-shaped snap ring 23. A compression spring 16 is mounted on the catch rod 2 and pressed between the bottom face of the receiving recess 13 of the fixing seat 1 and the snap ring 23.

The locking plate 3 is mounted on the catch rod 2 and has an inside formed with an eccentrically arranged locking hole 32 locked on the catch rod 2 in an inclined manner and has an end formed with a protruding insert 31 inserted into the insertion slot 12 of the fixing seat 1. A biasing member 33 is mounted on the catch rod 2 and biased between the fixing seat 1 and the locking plate 3 so that the locking plate 3 is normally disposed at an inclined state relative to the catch rod 2 as shown in FIG. 2 so as to lock the catch rod 2.

The anti-skid pad 4 is rotatably mounted on the catch rod 2 to move with the catch rod 2 and includes a pad body 40, an adjusting member 45 and a spring 44.

The pad body 40 is mounted on the bottom end of the catch rod 2 and has an inside having a top end formed with a mounting hole 41 mounted on the bottom end of the catch rod 2, a mediate portion formed with a stepped chamber 42 connected to the mounting hole 41 to allow movement of the resting portion 24 of the catch rod 2 and to limit the limit ring 26 of the catch rod 2, and a bottom end formed with a passage 43 connected to the stepped chamber 42.

The mounting hole 41 of the pad body 40 has a tapered-shape and has a diameter greater than that of the catch rod 2 so that a gap 410 is defined between the mounting hole 41 of the pad body 40 and the catch rod 2.

The stepped chamber 42 of the pad body 40 has a top portion 420 having a diameter grater than that of the mounting hole 41 and a bottom portion 421 having a diameter grater than that of the top portion 420. The limit ring 26 of the catch rod 2 is movably mounted in and limited by the top portion 420 of the stepped chamber 42 of the pad body 40 to prevent the catch rod 2 from being detached from the pad body 40 of the anti-skid pad 4. The bottom portion 421 of the stepped chamber 42 of the pad body 40 has an end face formed with a substantially arc-shaped stop flange 4210.

The passage 43 of the pad body 40 has an end face formed with a substantially arc-shaped guide face 431.

The adjusting member 45 is secured in the bottom portion 421 of the stepped chamber 42 of the pad body 40 and is directed toward the resting portion 24 of the catch rod 2. The adjusting member 45 is forcibly fitted through the passage 43 of the pad body 40 into the stepped chamber 42 of the pad body 40. The adjusting member 45 has a stepped shape and has a top portion formed with a substantially arc-shaped adjusting recess 452 directed toward the resting portion 24 of the catch rod 2 to pivotally receive the resting portion 24 of the catch rod 2 and a bottom portion having a periphery formed with a substantially arc-shaped resting flange 451 rested on and locked by the stop flange 4210 of the stepped chamber 42 of the pad body.

The spring 44 is pressed between the limit ring 26 of the catch rod 2 and the adjusting member 45 to push the resting portion 24 of the catch rod 2 to move away from the adjusting recess 452 of the adjusting member 45. The spring 44 has a top end mounted on the resting portion 24 of the catch rod 2 and a bottom end mounted on the top portion of the adjusting member 45. The spring 44 is forcibly fitted through the passage 43 of the pad body 40 into the stepped chamber 42 of the pad body 40.

Referring to FIGS. 1-3, the fixing seat 1 is secured to a bottom of a door 5 by the screw holes 11. When the door 5 is opened to a determined position, the pedal 21 of the catch rod 2 is stepped by a user to push the catch rod 2 downward to move the anti-skid pad 4 downward until the anti-skid pad 4 is rested on the ground 6 so that the door 5 is stopped by friction between the anti-skid pad 4 and the ground 6.

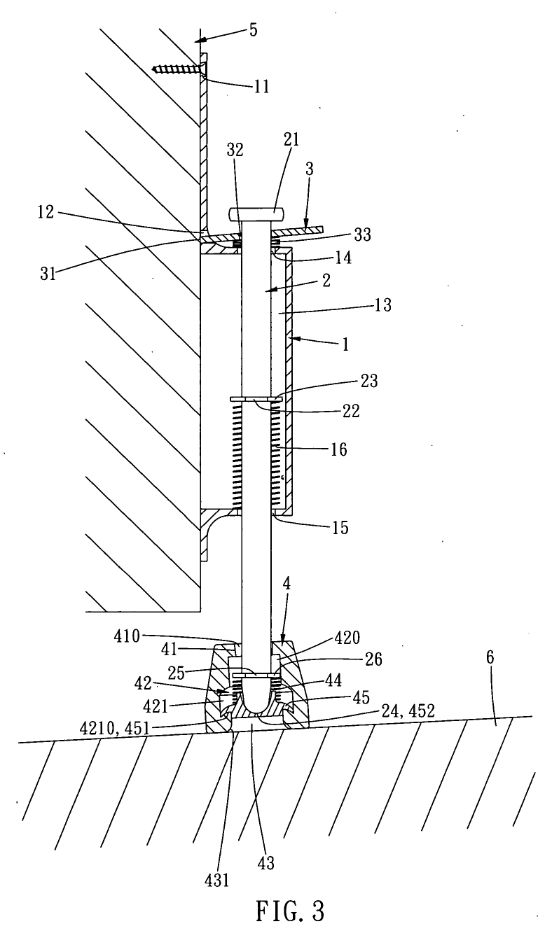

After the anti-skid pad 4 is rested on the ground 6, the adjusting member 45 is secured in the pad body 40 and the resting portion 24 of the catch rod 2 is movable in the stepped chamber 42 of the pad body 40 toward the adjusting member 45 until the resting portion 24 of the catch rod 2 is received in the adjusting recess 452 of the adjusting member 45 as shown in FIG. 3.

After the resting portion 24 of the catch rod 2 is rested on the adjusting member 45, the resting portion 24 of the catch rod 2 is rotatable in the adjusting recess 452 of the adjusting member 45 so that the anti-skid pad 4 is rotatable relative to the catch rod 2 by the gap 410 defined between the mounting hole 41 of the pad body 40 and the catch rod 2 so as to adjust the angle between the anti-skid pad 4 and the catch rod 2 freely. Thus, the anti-skid pad 4 is freely rotatable relative to the catch rod 2 to fit the inclined angle of the ground 6 so that the door stop has an automatic angle adjustment function so as to fit the inclined angle of the ground 6. In addition, the spring 44 is compressed during movement of the resting portion 24 of the catch rod 2 to produce an elastic compensation effect to the anti-skid pad 4, so that the anti-skid pad 4 is positioned on the ground 6 solidly and stably.

Accordingly, the anti-skid pad 4 is freely rotatable relative to the catch rod 2 to fit the inclined angle of the ground 6 so that the door stop has an automatic angle adjustment function so as to fit the inclined angle of the ground 6. In addition, the spring 44 is compressed during movement of the resting portion 24 of the catch rod 2 to produce an elastic compensation effect to the anti-skid pad 4, so that the anti-skid pad 4 is positioned on the ground 6 solidly and stably.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed:

1. A door stop, comprising a fixing seat, a catch rod, and an anti-skid pad, wherein:
the fixing seat has an inside formed with a receiving recess having a top face formed with a top through hole and a bottom face formed with a bottom through hole;
the catch rod is slidable through the receiving recess of the fixing seat and has a top end protruded outward from the top through hole of the fixing seat and formed with an enlarged pedal and a bottom end protruded outward from the bottom through hole of the fixing seat and formed with a resting portion and an annular retaining groove for retaining a limit ring;
the anti-skid pad is mounted on the catch rod to move therewith and is rotatable relative to the bottom end of the catch rod to adjust an angle between the anti-skid pad and the catch rod.

2. The door stop in accordance with claim 1, wherein the resting portion of the catch rod is substantially arc-shaped.

3. The door stop in accordance with claim 1, wherein the limit ring is substantially C-shaped.

4. The door stop in accordance with claim 1, wherein the catch rod has a mediate portion formed with an annular snapping groove for mounting a substantially C-shaped snap ring, and the door stop further comprises a compression spring mounted on the catch rod and pressed between the bottom face of the receiving recess of the fixing seat and the snap ring.

5. The door stop in accordance with claim 1, wherein the anti-skid pad is rotatable mounted on the catch rod.

6. The door stop in accordance with claim 1, wherein the anti-skid pad includes a pad body, an adjusting member and a spring;
the pad body is mounted on the bottom end of the catch rod and has an inside having a top end formed with a mounting hole mounted on the bottom end of the catch rod, a mediate portion formed with a stepped chamber connected to the mounting hole to allow movement of the resting portion of the catch rod and to limit the limit ring of the catch rod, and a bottom end formed with a passage connected to the stepped chamber;
the adjusting member is secured in the stepped chamber of the pad body and is directed toward the resting portion of the catch rod;
the spring is pressed between the limit ring of the catch rod and the adjusting member to push the resting portion of the catch rod to move away from the adjusting recess of the adjusting member.

7. The door stop in accordance with claim 6, wherein the mounting hole of the pad body has a tapered shape.

8. The door stop in accordance with claim 6, wherein the mounting hole of the pad body has a diameter greater than that of the catch rod so that a gap is defined between the mounting hole of the pad body and the catch rod.

9. The door stop in accordance with claim 6, wherein the stepped chamber of the pad body has a top portion having a diameter grater than that of the mounting hole and a bottom portion having a diameter grater than that of the top portion.

10. The door stop in accordance with claim 9, wherein the adjusting member is secured in the bottom portion of the stepped chamber of the pad body.

11. The door stop in accordance with claim 9, wherein the limit ring of the catch rod is movable in and limited by the top portion of the stepped chamber of the pad body to prevent the catch rod from being detached from the pad body of the anti-skid pad.

12. The door stop in accordance with claim 9, wherein the bottom portion of the stepped chamber of the pad body has an end face formed with a substantially arc-shaped stop flange, and the adjusting member has a top portion formed with a substantially arc-shaped adjusting recess directed toward the resting portion of the catch rod to pivotally receive the resting portion of the catch rod and a bottom portion having a periphery formed with a substantially arc-shaped resting flange rested on and locked by the stop flange of the stepped chamber of the pad body.

13. The door stop in accordance with claim 6, wherein the adjusting member has a stepped shape.

14. The door stop in accordance with claim 6, wherein the passage of the pad body has an end face formed with a substantially arc-shaped guide face.

15. The door stop in accordance with claim 6, wherein the adjusting member is forcibly fitted through the passage of the pad body into the stepped chamber of the pad body.

16. The door stop in accordance with claim 6, wherein the spring is forcibly fitted through the passage of the pad body into the stepped chamber of the pad body.

17. The door stop in accordance with claim 12, wherein the spring has a top end mounted on the resting portion of the catch rod and a bottom end mounted on the top portion of the adjusting member.

18. The door stop in accordance with claim 6, wherein the resting portion of the catch rod is movable in the stepped chamber of the pad body toward the adjusting member until the resting portion of the catch rod is received in the adjusting recess of the adjusting member.

19. The door stop in accordance with claim 18, wherein the spring is compressed during movement of the resting portion of the catch rod to produce an elastic compensation effect to the anti-skid pad.

20. The door stop in accordance with claim 12, wherein when the resting portion of the catch rod is rested on the adjusting member, the resting portion of the catch rod is rotatable in the adjusting recess of the adjusting member so that the anti-skid pad is rotatable relative to the catch rod by a gap defined between the mounting hole of the pad body and the catch rod so as to adjust the angle between the anti-skid pad and the catch rod.
